(19) United States
(12) Patent Application Publication
(10) Pub. No.: US 2001/0013186 A1
(43) Pub. Date: Aug. 16, 2001

(54) Method of providing an advertisement display on the handle of a door

(76) Inventor: Paul Malitas, Warrington, PA (US)

Correspondence Address: LaMORTE & ASSOCIATES, P.C., P.O. BOX 434, Yardley, PA, 19067, US

(21) Appl. No.: 09/817,603

(22) Filed: Mar. 26, 2001

Related U.S. Application Data
(63) Continuation-in-part of application No. 09/419,150, filed on Oct. 15, 1999, now abandoned.
(60) Provisional application No. 60/107,288, filed on Nov. 6, 1998.

(51) Int. Cl. G09F 23/00

(52) U.S. Cl. 40/599

(57) ABSTRACT

A handle assembly for use in apply advertisement space to the handle of a door. The handle assembly includes a display plate which serves as the structure that is actually grabbed by a person pushing or pulling the handle assembly. The display plate has a face surface that faces the person grabbing the handle assembly. Within the display plate is an interior chamber. The face surface of the display plate contains at least one transparent section that enables the interior chamber to be viewed by a person approaching the handle assembly. The interior chamber is sized to receive an advertisement display. Accordingly, a person approaching the handle assembly can view the advertisement display placed within the handle assembly. A mounting bracket is provided for mounting the display plate in a fixed position relative the door. The mounting bracket can attach the display plate either directly to the door or to a preexisting handle that is already present on the door.

### RELATED APPLICATIONS

This application is a Continuation-In-Part of copending U.S. patent application Ser. No. 09/419,150, entitled Door Handle Advertising Display And Method, which was filed Oct. 15, 1999 and claims the benefit of U.S. Provisional application Ser. No. 60/107,288, entitled Door Handle Advertising Display, which was filed Nov. 6, 1998.

### BACKGROUND OF THE INVENTION

1. Field of the Invention

In general, the present invention relates to handles for doors. More particularly, the present invention is related to methods for altering handles for doors so that they can contain advertisements or other display information.

2. Description of the Prior Art

In the prior art there are many types of displays that are intended to hold advertisements. Many of these displays are specifically designed to be attached to doors, especially doors of retail stores. However, people often ignore the advertisements as they pass into and out of door.

What cannot be ignored is the handle to the door. When a person approaches a door, they instinctively look for and at the handle to the door. What is needed is a way to provide advertising space on the handle of the door so that the advertisement will be noticed as a person uses the door. This need is met by the present invention as described and claimed below.

### SUMMARY OF THE INVENTION

The present invention is a method of placing an advertisement display on the handle of a door by adding a new handle assembly to the door. The handle assembly includes a display plate which serves as the structure that is actually grabbed by a person pushing or pulling the handle assembly. The display plate has a face surface that faces the person grabbing the handle assembly. Within the display plate is an interior chamber. The face surface of the display plate contains at least one transparent section that enables the interior chamber to be viewed by a person approaching the handle assembly. The interior chamber is sized to receive an advertisement display. Accordingly, a person approaching the handle assembly can view the advertisement display placed within the handle assembly.

A mounting bracket is provided for mounting the display plate in a fixed position relative the door. The mounting bracket can attach the display plate either directly to the door or to a preexisting handle that is already present on the door.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a perspective view of an exemplary embodiment of a door containing a handle assembly in accordance with the present invention;

FIG. 2 is an exploded perspective view showing a first method of installing a door handle assembly in accordance with the present invention;

FIG. 3 is a cross-sectional view of the embodiment of the present invention shown in FIG. 2;

FIG. 4 is an exploded perspective view showing a second method of installing a door handle assembly in accordance with the present invention;

FIG. 5 is a top view of a second exemplary embodiment of a door handle assembly in accordance with the present invention;

FIG. 6 is a top view of a third exemplary embodiment of a door handle assembly in accordance with the present invention; and

FIG. 7 is a front view of one exemplary embodiment of a display plate in accordance with the present invention.

### DETAILED DESCRIPTION OF THE INVENTION

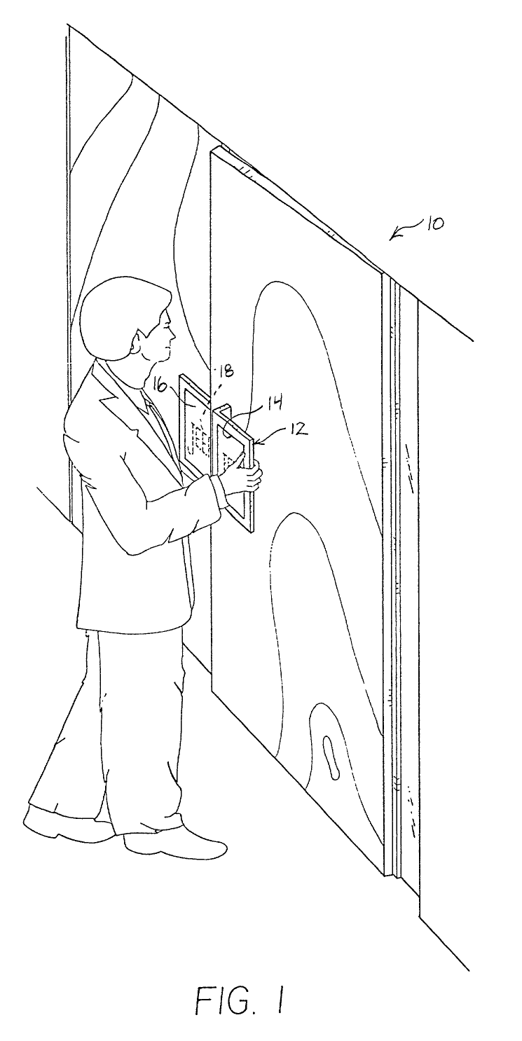

Referring to FIG. 1, there is shown a door 10. The door 10 is either pushed or pulled open. To facilitate the pushing or pulling of the door 10, a handle is traditionally provided on the door. In the prior art, door handles are typically labeled with the word “Push” or “Pull”. The door handle traditionally served no other purpose other than to provide as a convenient place to contact the door 10.

In the present invention, a door handle assembly 12 is provided with an advertisement display. Accordingly, as a person approaches the door 10 and reaches for the door handle assembly 12, that person will be exposed to the advertisement contained on the door handle assembly 12. The door handle assembly 12 can either attach to an existing door handle or can be substituted in place of a traditional door handle, as will be explained.

The door handle assembly 12 has a face surface 14 that is transparent in at least one section. The transparent section 16 of the face surface 14 can be either glass or plastic. Under the transparent section 16 of the face surface 14 is placed a replaceable advertisement 18. The advertisement 18 is therefore visible through the face surface 14 of the door handle assembly 12. The advertisement 18 can be selectively removed. Accordingly, different advertisements 18 can be placed into the door handle assembly 12 at different times. The advertisement space in the door handle assembly 12 is therefore well adapted for leasing to different manufactures.

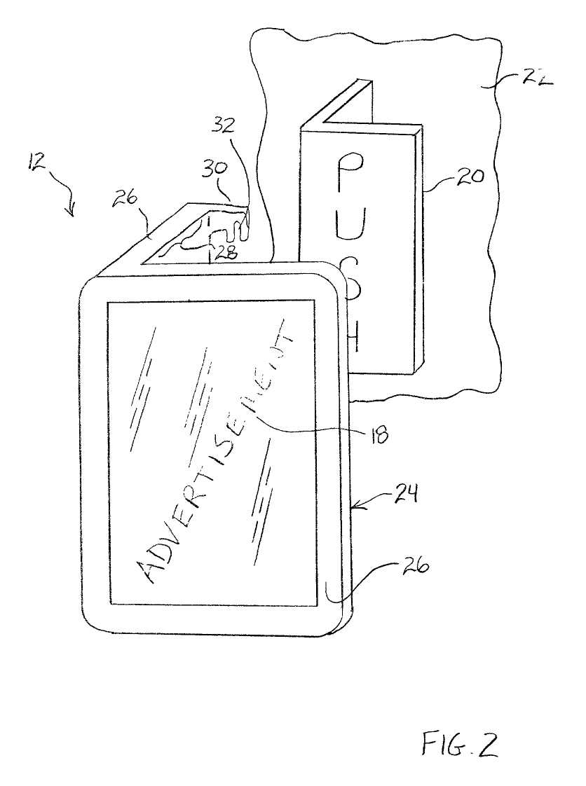

Referring to FIG. 2, a door handle assembly 12 is shown in conjunction with a traditional door handle 20. In a traditional door handle 20, the door handle 20 is mounted to the door 22 using two mounting screws that pass through the door 22. The present invention door handle assembly 12 is designed to attached to this traditional door handle 20.

The present invention door handle assembly 12 contains a display plate 24. It is the display plate 24 that is contacted by a person grabbing the door handle assembly 12. The advertisement 18 is viewable through the face surface 26 of the display plate 24. A bracket 26 extends rearwardly from the display plate 24. The bracket 26 has a main section 28 that extends at a perpendicular to the display plate 24. At the opposite end of the main section 28 of the bracket 26 are two narrow extensions 30. The narrow extensions 30 extend in parallel to the display plate 24.

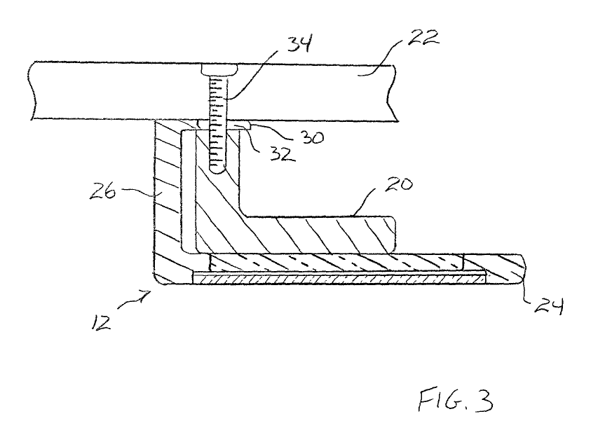

Referring to FIG. 2 in conjunction with FIG. 3, it can be seen that screw slots 32 are formed in the narrow extensions 30 of the bracket 26. To attach the present invention handle assembly 12 to the traditional door handle 20, the mounting bolts 34 that retain the traditional door handle 20 in place are loosened. The narrow extensions 30 on the bracket 26 of the present invention door handle assembly 12 are then slipped between the door 22 and the traditional door handle 20. The screw slots 32 in the narrow extensions 30 pass around the mounting bolts 34. The mounting bolts 34 are then tightened, thereby mounting the present invention door handle assembly 12 over the traditional door handle 20.

From FIG. 3, it can be seen that the display plate 24 of the door handle assembly 12 lays over the traditional door handle 20. As such, the traditional door handle 20 acts as a support for the larger door handle assembly 24.

It should be understood that in the embodiment of FIG. 2 and FIG. 3, the screw slot 32 in the narrow extensions 30 of the bracket can be replaced by a threaded aperture. Using a threaded aperture instead of a slot, the mounting bolts 34 can be used to attach the present invention door handle assembly 12 to the door without need of the traditional door handle 20. The traditional door handle 20 can therefore be removed and discarded if desired.

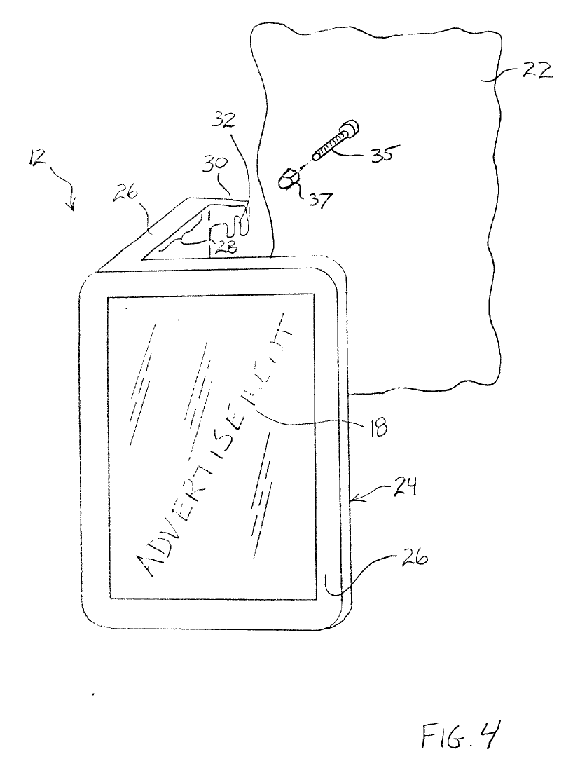

Referring to FIG. 4, a second method of attaching the present invention door handle assembly 12 to a door 22. In this method, the traditional door handle 20 (FIG. 1) is removed. The mounting bolts that held the traditional door handle in place are removed and replaced with new mounting bolts 35 of the appropriate length. Cap nut 37 are then used to bolt the present invention door handle assembly directly to the door 22. As such, the present invention door handle 12 is the sole handle assembly on the door 22.

In the prior art, there are many different types of door handles for doors. The present invention door handle assembly can be adapted for use with many of these different designs. Referring to FIG. 5, a conventional door handle 40 is shown of the type having only a single attachment point to a door 42. For such a configuration, the present invention door handle assembly 44 can be configured with looped brackets 48 that extend from the rear of the display plate 45. The looped brackets 48 pass over the conventional door handle 40 and engage the conventional door handle 40.

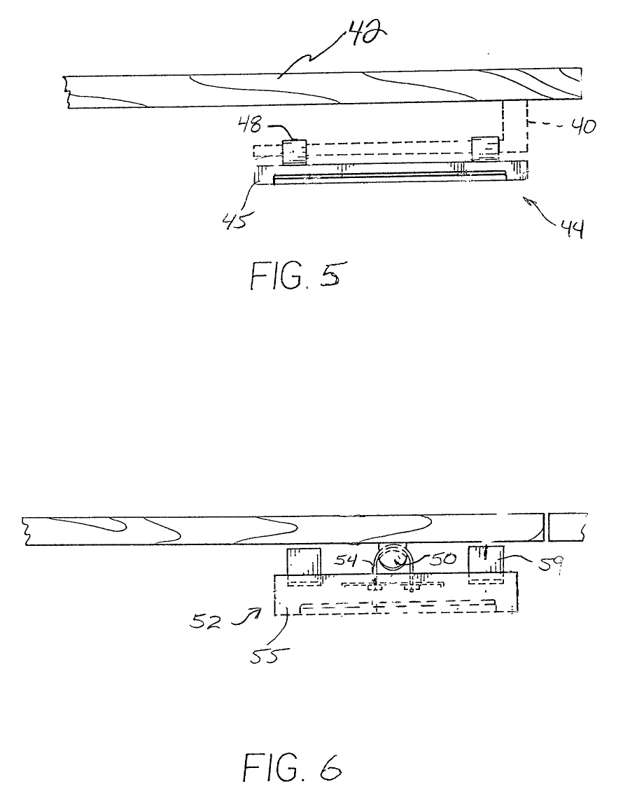

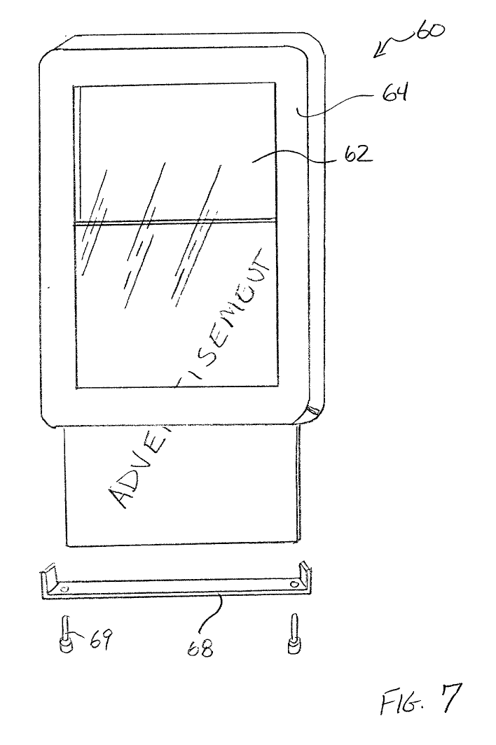

In FIG. 6, a conventional door handle is shown of the type having only a single cylindrical pull 50. For such a configuration, the present invention door handle assembly 52 can be configured with a set of mounting brackets 54 that extend from the rear of the display plate 55. The mounting brackets 54 pass around the conventional door handle 50 and engage the conventional door handle 50 when the mounting brackets are tightened. Spacers 59 are provided to prevent the display plate from teetering about the conventional door handle 50.

Regardless of how the display plate of the present invention mounts to a door or a conventional door handle, the structure of the display plate remains the same. The display plate contains an internal chamber that is sized to receive an advertisement. The advertisement placed in the chamber is viewable from outside the chamber through a segment of transparent material. The advertisement in the internal chamber must be accessible so that the advertisement can be periodically changed.

Referring to FIG. 7, an exemplary embodiment of a display plate 60 is illustrated. The display plate 60 defines an internal chamber 62. The face surface 64 of the display plate 60 contains at least one segment of a transparent material so that the internal chamber 62 is visible from a point external of the display plate 60. An access panel 68 is present at the bottom of the display plate 60. The access panel 68 enables a sheet of paper to be selectively introduced into the internal chamber 62. The access door is held in place by screws 69. The screws 69 may have specialized heads that require a keyed tool for removal, thereby reducing chances for vandalism.

The positioning of an access panel 68 at the bottom of the display plate 60 is merely exemplary. It should be understood that an access panel 68 can be provided along any surface that contacts the internal chamber. Alternatively, the display plate 60 can be constructed with a hinge that enables the face surface to be opened, thereby accessing the internal chamber. All such alterative methods of accessing the internal chamber can be adapted for use with the present invention.

Within the display plate 60, the rear surface of the display plate 60 may also be transparent. In this manner light can pass completely through the display plate 60. In this manner an advertisement can be back lit by light passing through the door and the rear of the display plate 60. Alternatively, the display plate may contain internal lighting. The lighting can be either battery powered, if the door has no electricity, or hard wired, if the door is provided with electricity. The lights can back lit the advertisement, thereby making the advertisement easier to see at night.

It should be understood that the specifics of the present invention described above illustrates only exemplary embodiments of the present invention. A person skilled in the art can therefore make numerous alterations and modifications to the described methods of installation utilizing functionally equivalent components to those shown and described. All such modifications are intended to be included within the scope of the present invention as defined by the appended claims.

What is claimed is:

1. A method of providing an advertisement display in the handle of a door, comprising the steps of:
providing a door handle assembly that contains and internal chamber and at least one transparent section for viewing into said internal chamber;
mounting said door handle assembly to said door;
placing an advertisement in said internal chamber so that said advertisement is viewable by a person utilizing said door handle assembly on said door.

2. The method according to claim 1, wherein said step of mounting said door handle assembly to said door includes the steps of removing a conventional handle from said door and mounting said door handle assembly in its place.

3. The method according to claim 1, wherein said step of mounting said door handle assembly to said door includes mounting said door handle assembly to a preexisting conventional door handle.

4. The method according to claim 1, wherein said door handle assembly includes a display plate that contains said internal chamber and a mounting bracket.

5. The method according to claim 4, wherein said step of mounting said door handle assembly to said door includes bolting a conventional door handle to said door and placing a section of said mounting bracket between said door and said conventional door handle.

6. A method of displaying an advertisement on a door, comprising the steps of:
providing a handle assembly having a display plate and at least one mounting bracket, wherein said display plate defines an internal chamber and has at least one transparent section that enables said internal chamber to be viewed;
connecting said handle assembly to the door with said at least one mounting bracket;
placing an advertisement in said internal chamber, wherein said advertisement is viewable through said internal chamber.

7. The method according to claim 6, wherein said step of connecting said handle assembly to the door includes the steps of removing a conventional handle from said door and mounting said handle assembly in its place.

8. The method according to claim 6, wherein said step of connecting said handle assembly to said door includes mounting said at least one mounting bracket to a preexisting conventional door handle.

9. The method according to claim 6, wherein said step of connecting said handle assembly to said door includes bolting a conventional door handle to said door and placing said at least one mounting bracket between said door and said conventional door handle.

10. The method according to claim 6, wherein said step of placing an advertisement in said internal chamber includes opening an access panel on said display plate and placing a paper advertisement in said internal chamber.

11. A method of displaying a removable printed advertisement on a door, comprising the steps of:
mounting a handle assembly to the door, wherein the handle assembly defines an internal chamber viewable through at least one transparent window;
placing said printed advertisement in the internal chamber, wherein said printed advertisement is viewable through said at least one transparent window.

12. The method according to claim 11, wherein said step of mounting a handle assembly includes bolting the handle assembly directly to the door.

13. The method according to claim 11, wherein said step of mounting a handle assembly includes attaching the handle assembly to a preexisting handle already mounted on said door.

14. The method according to claim 11, wherein at least one window is located on either side of said printed advertisement, thereby enabling ambient light to back light at least some of said printed advertisement
